(19) United States
(12) Patent Application Publication
(10) Pub. No.: US 2004/0054615 A1
(43) Pub. Date: Mar. 18, 2004

(54) Method of dynamically lowering bid price through network and apparatus therefor

(75) Inventor: Yu-Hsin Lin, Taipei (TW)

Correspondence Address: BACON & THOMAS, PLLC, 625 SLATERS LANE, FOURTH FLOOR, ALEXANDRIA, VA, 22314

(73) Assignee: Sheng-Hsiung HSU, Taipei (TW)

(21) Appl. No.: 10/245,347

(22) Filed: Sep. 18, 2002

(51) Int. Cl. G06F 17/60

(52) U.S. Cl. 705/37

(57) ABSTRACT

Method of dynamically lowering bid price of a product through network as bidding proceeds and apparatus therefor are provided. A difference of amount between an initial bid price having a higher value and a final price having a lower value is subsidized by an accumulated subsidy equal to a subsidy ratio times a communication income which is a product of a communication income per time unit and time units passed.

### BACKGROUND OF THE INVENTION

1. Field of the Invention

The present invention relates to bidding procedure and more particularly to a method of dynamically lowering bid price of a product through network (e.g., the Internet) as bidding proceeds in which a difference of amount between an initial bid price having a higher value and a final bid price having a lower value is subsidized by fees incurred from the network communication. The present invention also relates an apparatus for dynamically lowering bid price of the product through network.

2. Description of Related Art

A conventional method of bidding a product comprises setting a lowest bid price, raising the bid price by a predetermined amount if more than two bidders are competing at the bid price, and deciding a winner if there is only one bidder competing at the raised bid price. A difference between the final bid price having a higher value and the initial bid price having a lower value is the income of the bid provider. It is understood that the more competing of the bidding the higher income of the bid provider. However, vast consumers may not be interested in it in the long run due to a lack of stimulus. In a typical case fewer and fewer consumers will attend the bid. As a result, the income of the bid provider is reduced significantly because products are sold slowly. To the worse, such type of bidding cannot maintain for a long time. Thus, the conventional bidding method is limited in applications. Further, it is impossible of offering a price lower than the initial bid price for consumers to compete. Thus improvement exists.

### SUMMARY OF THE INVENTION

It is an object of the present invention to provide a process of dynamically lowering bid price of one of a plurality of products through network comprising calculating a communication income from a plurality of potential bidders every t seconds of time and appropriating a portion of the communication income as a subsidy for one of the products so that the bid price of the product is capable of being dynamically lowered.

It is another object the present invention to provide a process of dynamically lowering bid price of one of a plurality of products through network wherein price of a product to be bid is partially subsidized by a communication income from a plurality of bidders. Hence, it is possible of providing the product in a price much lower than that being commercially available. In an extreme case the bid provider still can obtain a profit even when the product is free. This brings a win policy for all of bidders, the bid provider, and the communication provider.

It is further object of the present invention to provide a process of dynamically lowering bid price of one of a plurality of products wherein the bid provider can dynamically adjust bid price, communication charge, and subsidy ratio by observing the bidding process so as to obtain a maximum profit as well as reduce the bid price as much as possible.

It is still further object of the present invention to provide a process of dynamically lowering bid price of one of a plurality of products comprising utilizing a DPC (Data Processing Center) having a mechanism for dynamically lowering bid price to form a bidding network accessible by means of voice communication, text communication, graphics communication, video communication, or combinations thereof; defining t seconds as a time unit; charging one of a plurality of potential bidders by means of parameters; calculating a communication income from the bidders, each accessing the bidding network by means of voice communication, text communication, graphics communication, video communication, or combinations thereof in each time unit; and appropriating a portion of the communication income as a subsidy for one of the products by means of the DPC so that the bid price of the product is capable of being dynamically lowered throughout the process. By utilizing the process, a number of advantages, characteristics, and additional objects are obtained as below:

1. For increasing an interaction between the bid provider and the bidders and attracting more potential bidders, a plurality of communication means are provided to the bidders for participating the bidding in which the bidding network may be one of the following:

a bidding network accessible by voice communication and text communication;

a bidding network accessible by voice communication, text communication, and graphics communication and coupled to the Internet;

a bidding network accessible by voice communication, text communication, and video communication and coupled to the Internet;

a bidding network accessible by voice communication, text communication, graphics communication, and video communication and coupled to the Internet;

a bidding network accessible by voice communication and graphics communication and coupled to the Internet;

a bidding network accessible by voice communication and video communication and coupled to the Internet;

a bidding network accessible by text communication, graphics communication, and video communication and coupled to the Internet; and

a bidding network accessible by graphics communication and video communication and coupled to the Internet.

II. The process comprises charging one of a plurality of potential bidders by means of parameters in each time unit of t seconds; calculating a communication income from the bidders which are accessing the bidding network by means of one the above communications; and appropriating a portion of the communication income based on a predetermined subsidy ratio as a subsidy for one of the products so that the bid price of the product is capable of being dynamically lowered throughout the process.

III. Defines a type of charge as charge by time, charge by times, charge by data size of 128 bytes, charge by point, or membership fee per month.

IV. A communication income per second is a summation of respective one of the rate equations times the corresponding number of the online bidders.

V. Setting values of the process comprises market price of X, cost as 80% of X, and subsidy ratio of G %. Also, values of X and G and parameters A to E are variables. In other words, the bid provider can dynamically adjust them depending on the current bidding conditions in order to obtain a balance between the number of bidders and income of the bid provider.

VI. A communication income is the communication income per time unit times a period of time t defined as Ri=Fi*ti, a communication subsidy is the subsidy ratio G % times the communication income defined as Si=Ri* the subsidy ratio G %, the accumulated subsidy is a summation of respective ones of the communication subsidy defined as Ti=Σ Si, and the latest bid price is a subtraction of the accumulated subsidy from a cost of the product defined as Mi=the cost−Ti.

VII. In a case that the bidding is busy (i.e., the number of bidders increased steadily) t is set as one second. That is, the apparatus will be updated per second for increasing the number of times of dynamically lowering bid price of a product. In another case that the bidding is slow (i.e., the number of bidders reduced significantly) t is set as 10, 20, 30, or 60 seconds. That is, the apparatus will be updated per t second(s).

VII. In a preferred flow chart of the process, each message is prompted by means of voice communication, text communication, graphics communication, video communication, or combinations thereof.

IX. Information provided in accordance with the eNumber of the bid winner is sent through mails, messages, call-outs, pagers, the Web, TVs, radios, newspapers, and magazines depending on applications.

X. Information provided to the bid winner can be sent through mails, messages, call-outs, pagers, the Web, TVs, radios, newspapers, and magazines. Such information broadcasting may additionally form business relationship with other trades for obtaining advertisement therefrom.

The above and other objects, features and advantages of the present invention will become apparent from the following detailed description taken with the accompanying drawings.

### BRIEF DESCRIPTION OF THE DRAWINGS

FIG. 1 presents schematically the telephone connection of a bidder to an apparatus for dynamically lowering bid price of a product according to a first preferred embodiment of the invention;

FIG. 2 presents schematically the telephone connection of a bidder to an apparatus for dynamically lowering bid price of a product according to a second preferred embodiment of the invention;

FIG. 3 presents schematically the telephone connection of a bidder to an apparatus for dynamically lowering bid price of a product according to a third preferred embodiment of the invention;

FIG. 4 presents schematically the telephone connection of a bidder to an apparatus for dynamically lowering bid price of a product according to a fourth preferred embodiment of the invention;

FIG. 5 presents schematically the telephone connection of a bidder to an apparatus for dynamically lowering bid price of a product according to a fifth preferred embodiment of the invention;

FIG. 6 presents schematically the telephone connection of a bidder to an apparatus for dynamically lowering bid price of a product according to a sixth preferred embodiment of the invention;

FIG. 7 presents schematically the telephone connection of a bidder to an apparatus for dynamically lowering bid price of a product according to a seventh preferred embodiment of the invention;

FIG. 8 presents schematically the telephone connection of a bidder to an apparatus for dynamically lowering bid price of a product according to a eighth preferred embodiment of the invention;

FIG. 9 is a table illustrating a variety of techniques of charging a bidder according to the invention;

FIG. 9A is a diagram illustrating equations of calculating communication income according to the invention;

FIG. 10 is a table showing setting values according to the invention;

FIG. 11 is a table illustrating a variety of functions of dynamically lowering bid price of a product according to the invention;

FIG. 12 is a flow chart illustrating a process according to the invention;

FIGS. 13, 13A, and 13B are respective flow charts illustrating details of the process shown in FIG. 12;

FIG. 14 is a flow chart illustrating a variation of the process shown in FIG. 12 according to the invention;

FIG. 15 is a flow chart illustrating details of the process shown in FIG. 14;

FIGS. 16A to 16F are block diagrams showing messages shown in the first to the sixth preferred embodiments of the invention respectively;

FIG. 17 plots current bid price versus time with reference to market price and cost utilized in any preferred embodiment of the invention; and

FIG. 18 plots a detail of bid price versus a time unit of FIG. 17.

### DETAILED DESCRIPTION OF THE PREFERRED EMBODIMENTS

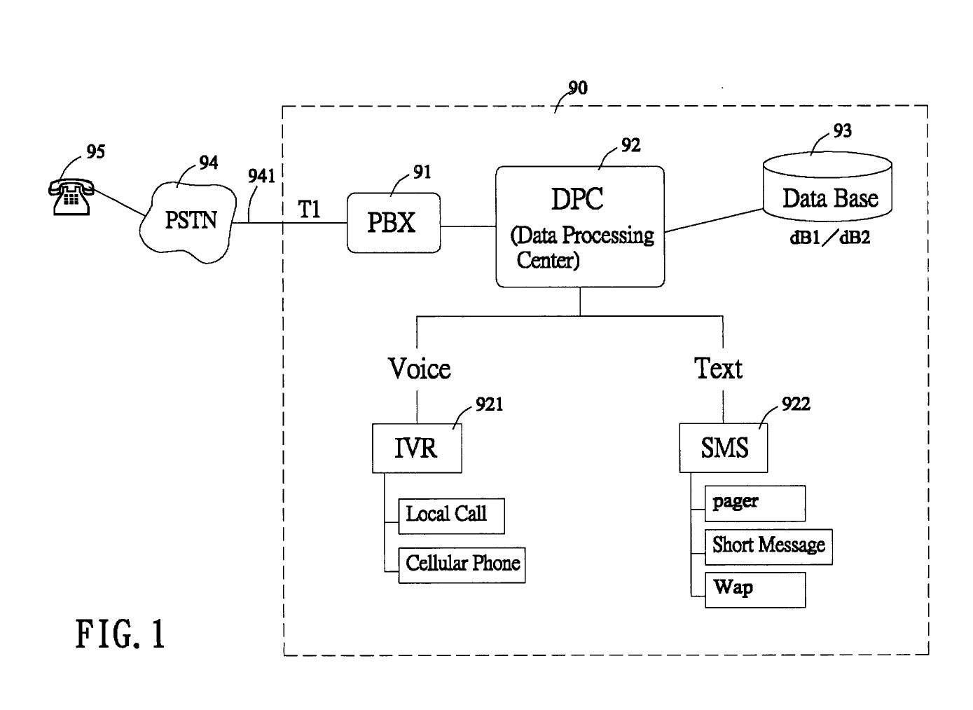

Referring to FIG. 1, there is shown the telephone connection of a bidder to an apparatus 90 according to a first preferred embodiment of the invention. The apparatus 90 comprises a PBX (Private Branch Exchange) 91 coupled to a telephone 95 of the bidder via a dedicated line 941 (e.g., T1 (Trunk Level 1)) and an existing PSTN (Public Switch Telephone Network) 94, a DPC (Data Processing Center) 92 for dynamically lowering bid price of a product and including an IVR (Interactive Voice Response) 921 for exchanging voice in a local call and a cellular phone and a SMS (Simple Message Server) 922 for exchanging text in WAP (Wireless Application Protocol), sending short messages to a cellular phone, and sending messages to a pager, and a database 93 coupled to the DPC 92, the database 93 including an eNumber membership database dB1 and a product database dB2.

This forms a bidding network accessible by means of voice or text communication by the bidder. Also, with this configuration, the bidder can access to the apparatus 90 for bidding. Prior to bid, the bidder can obtain detailed descriptions, bid prices, etc. of products by means of voice or text communication. In the bidding process, the DPC 92 can integrate real time information about the bidding in order to dynamically lower bid price of a product and show corresponding messages to the bidders. As a result, the bidding becomes more attractive to the bidders.

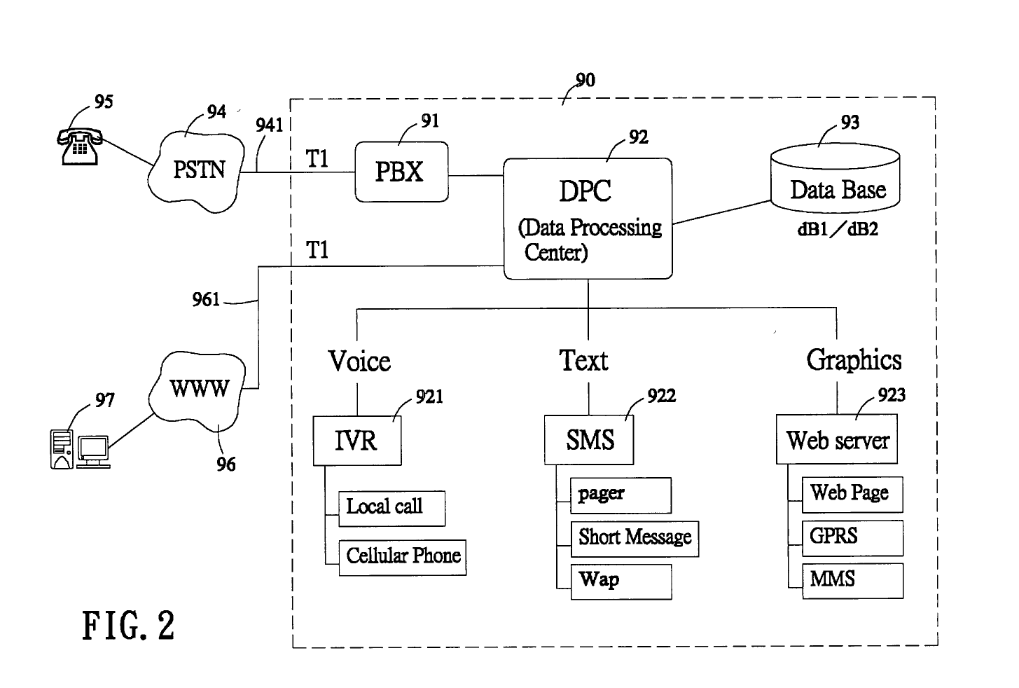

Referring to FIG. 2, there is shown the telephone connection of a bidder to an apparatus 90 according to a second preferred embodiment of the invention. The apparatus 90 comprises a PBX 91 coupled to a telephone 95 of the bidder via a dedicated line 941 (e.g., T1) and an existing PSTN 94, a DPC 92 coupled to a remote computer 97 of another bidder via a dedicated line 961 (e.g., T1) and WWW (World Wide Web) 96 for dynamically lowering bid price of a product, the DPC 92 including an IVR 921 for exchanging voice between a local call and a cellular phone, a SMS 922 for exchanging text in WAP, sending short messages to a cellular phone, and sending messages to a pager, and a Web server 923 for exchanging graphrics in communication among Web pages, GPRSs (General Packet Radio Services), and MMSs (Multimedia Message Services), and a database 93 coupled to the DPC 92, the database 93 including an eNumber membership database dB1 and a product database dB2.

This forms a bidding network accessible by means of voice, text, or graphics communication by the telephone 95 or the computer 97. Also, with this configuration, the bidder can access to the apparatus 90 for bidding. Prior to bid, the bidder can obtain detailed descriptions, bid prices, etc. of products by means of voice, text, or graphics communication. In the bidding process, the DPC 92 can integrate real time information about the bidding in order to dynamically lower bid price of a product and show corresponding messages to the bidders. As a result, the bidding becomes more attractive to the bidders.

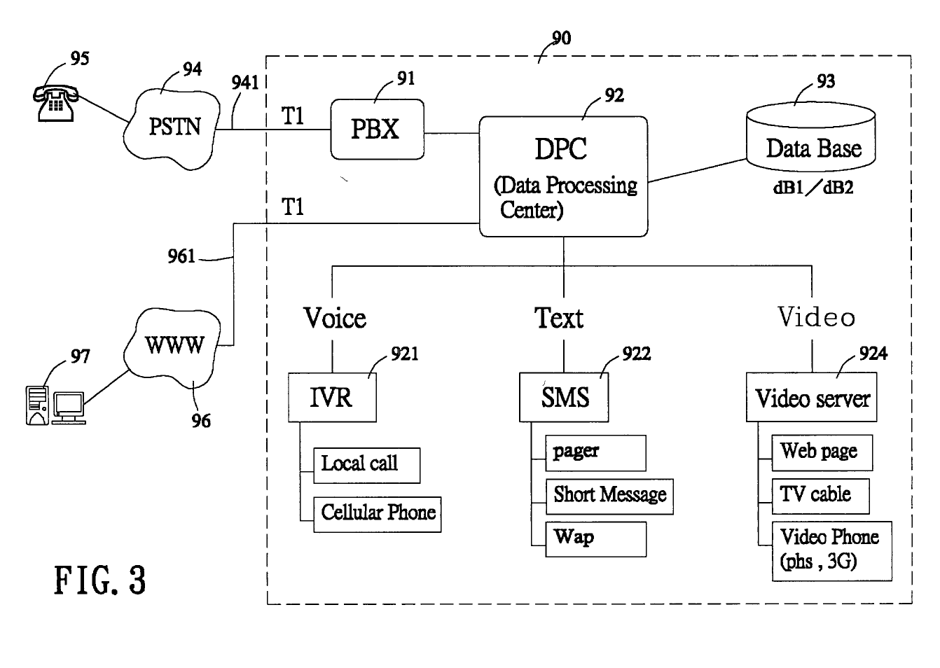

Referring to FIG. 3, there is shown the telephone connection of a bidder to an apparatus 90 according to a third preferred embodiment of the invention. The apparatus 90 comprises a PBX 91 coupled to a telephone 95 of the bidder via a dedicated line 941 (e.g., Ti) and an existing PSTN 94, a DPC 92 coupled to a remote computer 97 of another bidder via a dedicated line 961 (e.g., T1) and WWW 96 for dynamically lowering bid price of a product, the DPC 92 including an IVR 921 for exchanging voice in a local call and a cellular phone, a SMS 922 for exchanging text in WAP, sending short messages to a cellular phone, and sending messages to a pager, and a video server 924 for exchanging video in communication among Web pages, cable TV, and video phone such as PHS (Personal Handyphone System) or 3G (3rd Generation cellular phone), and a database 93 coupled to the DPC 92, the database 93 including an eNumber membership database dB1 and a product database dB2.

This forms a bidding network accessible by means of voice, text, or video communication by the telephone 95 or the computer 97. Also, with this configuration, the bidder can access to the apparatus 90 for bidding. Prior to bid, the bidder can obtain detailed descriptions, bid prices, etc. of products by means of voice, text, or video communication. In the bidding process, the DPC 92 can integrate real time information about the bidding in order to dynamically lower bid price of a product and show corresponding messages to the bidders. As a result, the bidding becomes more attractive to the bidders.

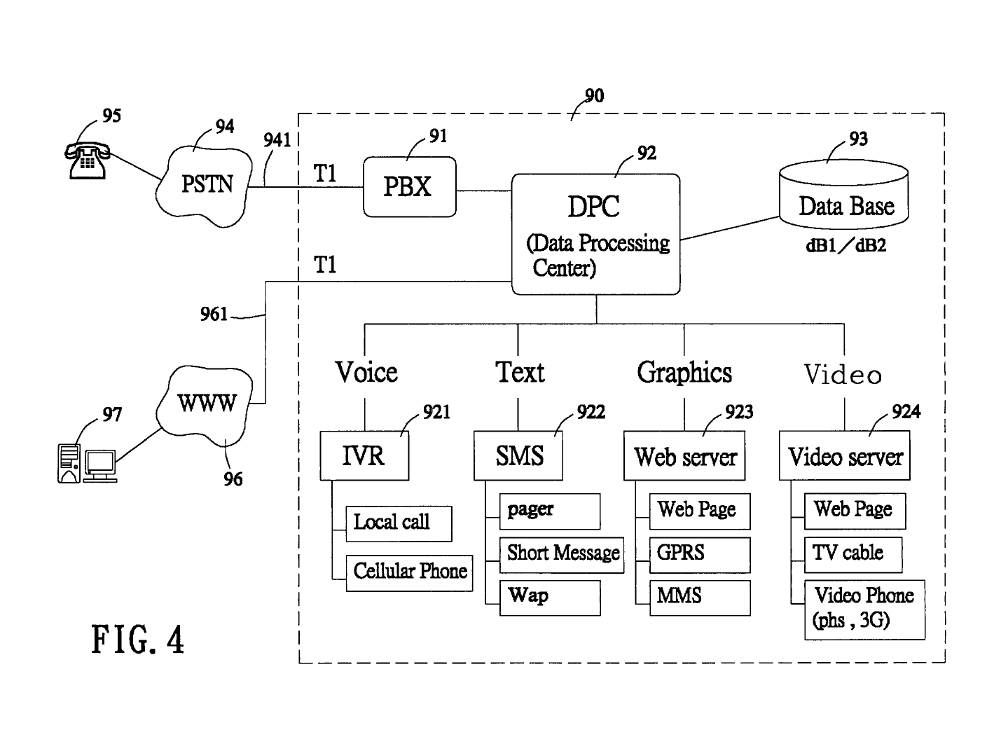

Referring to FIG. 4, there is shown the telephone connection of a bidder to an apparatus 90 according to a fourth preferred embodiment of the invention. The apparatus 90 comprises a PBX 91, a DPC 92, and a database 93, wherein the PBX is coupled to a telephone 95 of the bidder via a dedicated line 941 (e.g., T1) and an existing PSTN 94; the DPC 92 is coupled to a remote computer 97 of another bidder via a dedicated line 961 (e.g., T1) and WWW 96 for dynamically lowering bid price of a product, the DPC 92 includes an IVR 921 for exchanging voice between a local call and a cellular phone, a SMS 922 for exchanging text in WAP, s sending short messages to a cellular phone, and sending messages to a pager, a Web server 923 for exchanging graphics in communication among Web pages, GPRSs, and MMSs, and a video server 924 for exchanging video in communication among Web pages, cable TV, and video phone such as PHS or 3G, and the database 93 is coupled to the DPC 92, the database 93 includes an eNumber membership database dB1 and a product database dB2.

This forms a bidding network accessible by means of voice, text, graphics, or video communication by the telephone 95 or the computer 97. Also, with this configuration, the bidder can access to the apparatus 90 for bidding. Prior to bid, the bidder can obtain detailed descriptions, bid prices, etc. of products by means of voice, text, graphics, or video communication. In the bidding process, the DPC 92 can integrate real time information about the bidding in order to dynamically lower bid price of a product and show corresponding messages to the bidders. As a result, the bidding becomes more attractive to the bidders.

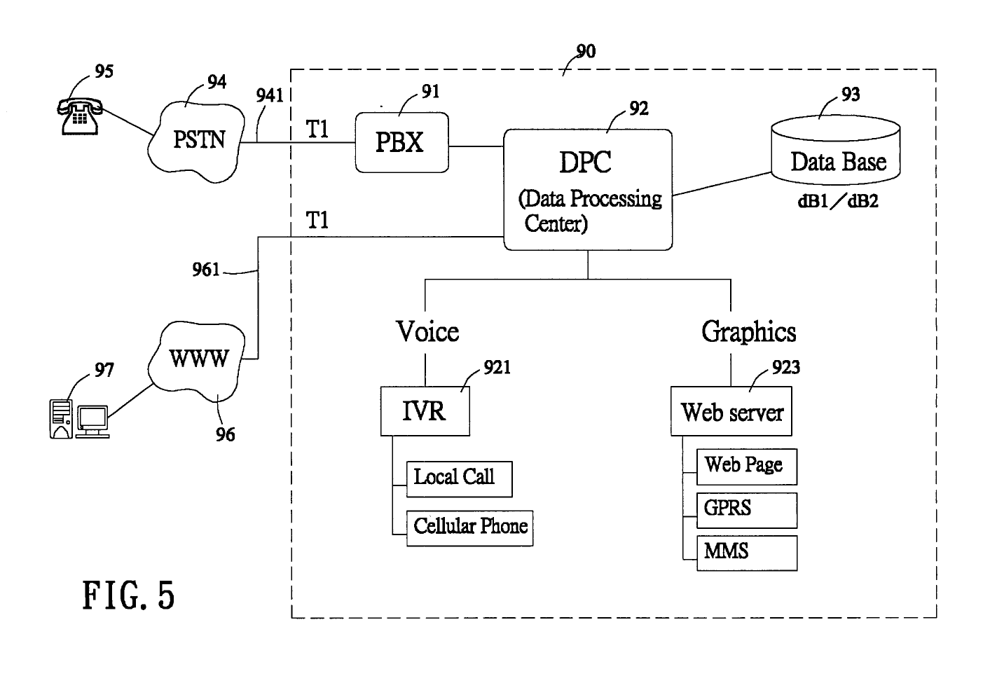

Referring to FIG. 5, there is shown the telephone connection of a bidder to an apparatus 90 according to a fifth preferred embodiment of the invention. The apparatus 90 comprises a PBX 91, a DPC 92, and a database 93, wherein the PBX 91 is coupled to a telephone 95 of the bidder via a dedicated line 941 (e.g., T1) and an existing PSTN 94; the DPC 92 is coupled to a remote computer 97 of another bidder via a dedicated line 961 (e.g., T1) and WWW 96 for dynamically lowering bid price of a product, the DPC 92 includes an IVR 921 for exchanging voice in a local call and a cellular phone and a Web server 923 for exchanging graphics in communication among Web pages, GPRSs, and MMSs; and the database 93 is coupled to the DPC 92, the database 93 includes an eNumber membership database dBl and a product database dB2.

This forms a bidding network accessible by means of voice or graphics communication by the telephone 95 or the computer 97. Also, this is one of alternative forms of the invention.

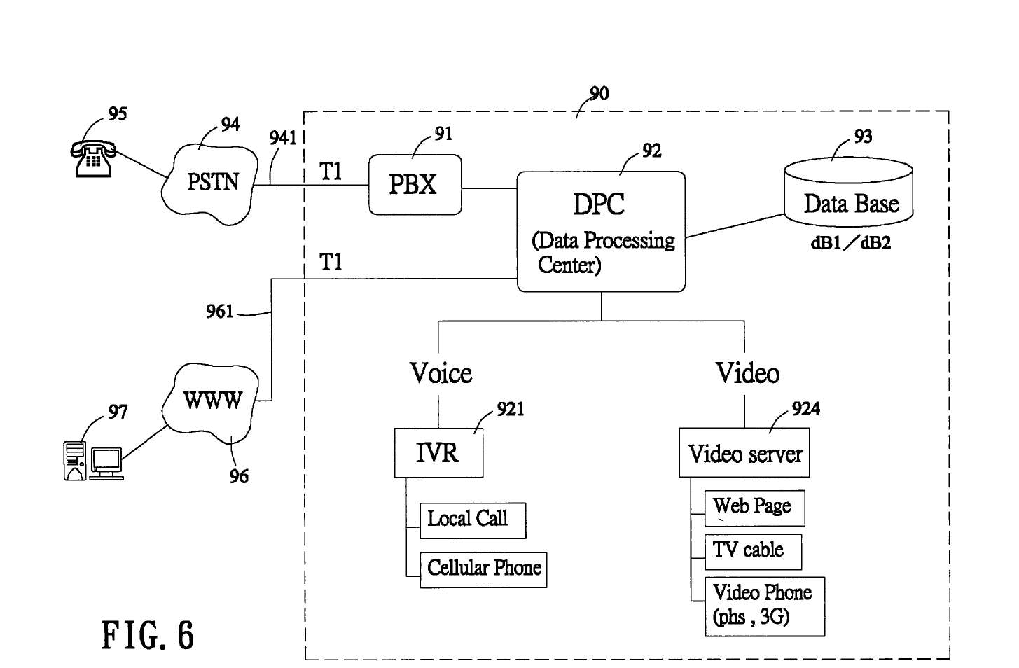

Referring to FIG. 6, there is shown the telephone connection of a bidder to an apparatus 90 according to a sixth preferred embodiment of the invention. The apparatus 90 comprises a PBX 91, a DPC 92, and a database 93, wherein the PBX 91 is coupled to a telephone 95 of the bidder via a dedicated line 941 (e.g., T1) and an existing PSTN 94; the DPC 92 is coupled to a remote computer 97 of another bidder via a dedicated line 961 (e.g., T1) and WWW 96 for dynamically lowering bid price of a product, the DPC 92 includes an IVR 921 for exchanging voice in a local call and a cellular phone and a video server 924 for exchanging video in communication among Web pages, cable TV, and video phone such as PHS or 3G; and the database 93 is coupled to the DPC 92, the database 93 includes an eNumber membership database dBl and a product database dB2.

This forms a bidding network accessible by means of voice or video communication by the telephone 95 or the computer 97. Also, this is one of alternative forms of the invention.

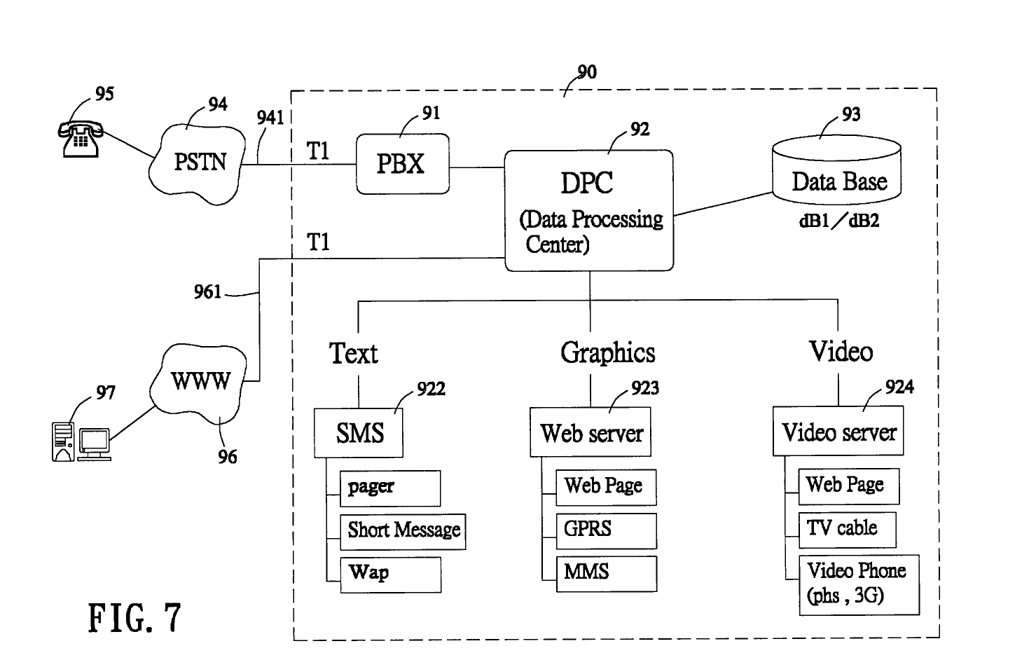

Referring to FIG. 7, there is shown the telephone connection of a bidder to an apparatus 90 according to a seventh preferred embodiment of the invention. The apparatus 90 comprises a PBX 91, a DPC 92, and a database 93, wherein the PBX 91 is coupled to a telephone 95 of the bidder via a dedicated line 941 (e.g., T1) and an existing PSTN 94; the DPC 92 is coupled to a remote computer 97 of another bidder via a dedicated line 961 (e.g., T1) and WWW 96 for dynamically lowering bid price of a product, the DPC 92 includes a SMS 922 for exchanging text in WAP, sending short messages to a cellular phone, and sending messages to a pager, a Web server 923 for exchanging graphics in communication among Web pages, GPRSs, and MMSs, and a video server 924 for exchanging video in communication among Web pages, cable TV, and video phone such as PHS or 3G; and the database 93 is coupled to the DPC 92, the database 93 including an eNumber membership database dB1 and a product database dB2.

This forms a bidding network accessible by means of text, graphics, or video communication by the telephone 95 or the computer 97. Also, this is another alternative form of the invention.

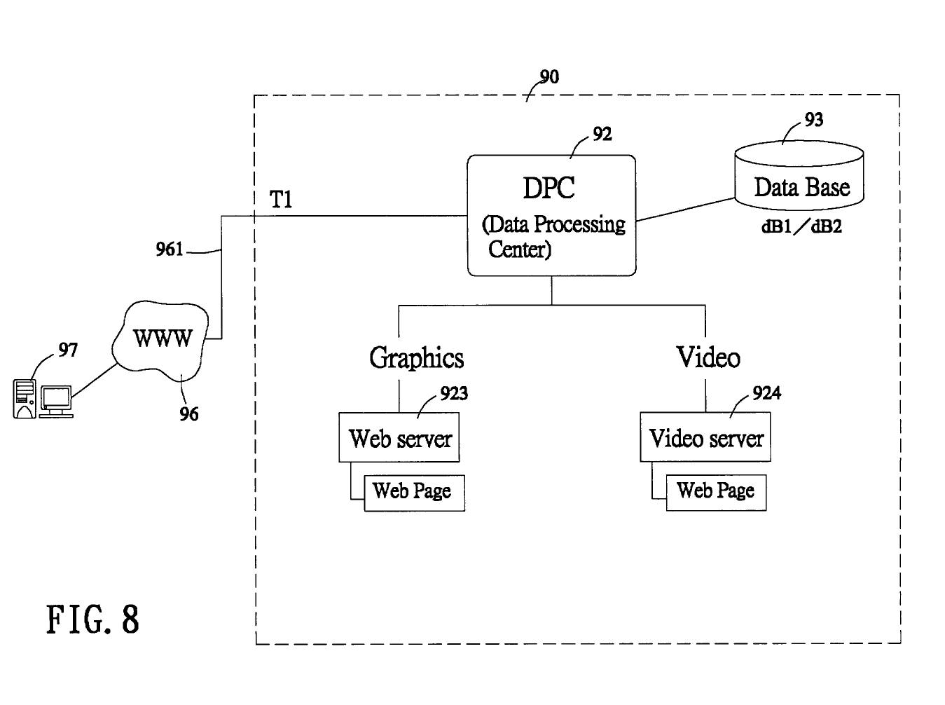

Referring to FIG. 8, there is shown the telephone connection of a bidder to an apparatus 90 according to an eighth preferred embodiment of the invention. The apparatus 90 comprises a DPC 92 and a Database 93 wherein the DPC is coupled to a remote computer 97 of another bidder via a dedicated line 961 (e.g., T1) and WWW 96 for dynamically lowering bid price of a product, the DPC 92 includes a Web server 923 for exchanging graphics in communication among Web pages and a video server 924 for exchanging video in communication among Web pages; and the database 93 is coupled to the DPC 92, the database 93 includes an eNumber membership database dB1 and a product database dB2.

This forms a bidding network accessible by means of graphics or video communication by the computer 97. Also, this is still another alternative form of the invention.

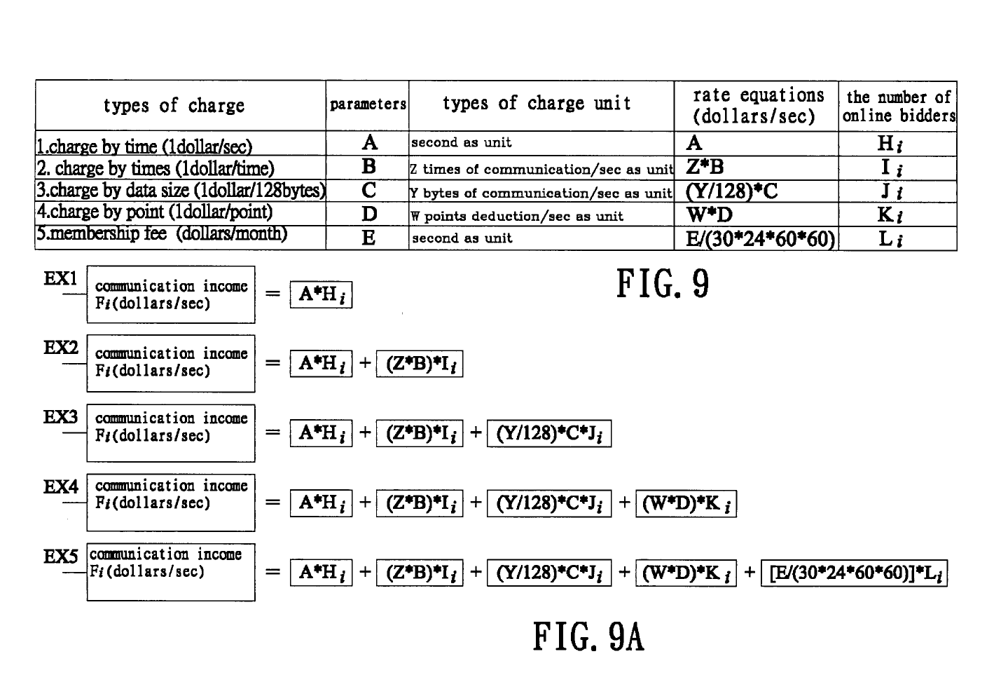

Referring to FIG. 9, there is shown a table illustrating a variety of techniques of charging a bidder according to the invention. Types of charge comprises charge by time (e.g., one US dollar/second), charge by times (e.g., one US dollar/time), charge by data size (e.g., one US dollar/128 bytes), charge by point (e.g., one US dollar/point), and membership fee (e.g., a predetermined amount of US dollar/month). Correspondingly, parameters comprises A, B, C, D, and E. Correspondingly, types of charge unit comprises a second as a unit, Z times of communication per second as a unit, Y bytes of communication per second as a unit, W points deduction per second as a unit, and a second as a unit. Correspondingly, rate equations comprises A, Z×B, (Y/128)×C, W×D, and E/(30×24×60×60). Correspondingly, the number of online bidders is Hi, Ii, Ji, Ki, or Li.

Referring to FIG. 9A, there is shown a diagram illustrating equations of calculating communication income according to the invention. For example, EX1 regarding a communication income Fi per second is defined as A×H1, EX2 regarding a communication income Fi per second per time is defined as A×Hi+(Z×B)×li, EX3 regarding a communication income Fi per second per time per 128 bytes is defined as A×Hi+(Z×B)×li+(Y/128)×C×J1, EX4 regarding a communication income Fi per second per time per 128 bytes per point is defined as A×Hi+(Z×B)×li+(Y/128)×C×Ji+(W×D)×Ki, and EX5 regarding a communication income Fi per second per time per 128 bytes per point per membership is defined as A×Hi+(Z×B)×li+(Y/128)×C×Ji+(W×D)×Ki+(E/(30×24×60×60))×Li. The bid provider can implement one of five equations described above for obtaining an appropriate rate. As seen from the equations, the communication income per second Fi (e.g., US dollars/second) is a summation of respective rate equations times the corresponding number of online bidders.

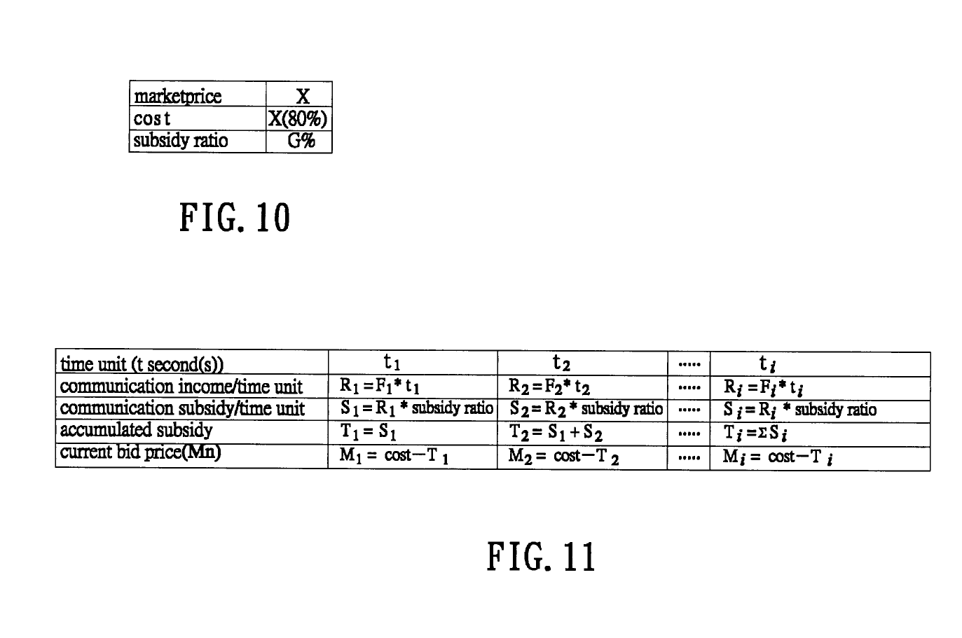

Referring to FIG. 10, there is shown a table of setting values according to the invention. The setting values comprise market price of X, cost as 80% of X, and subsidy ratio of G %. Note that values of X and G and parameters A to E are variables. In other words, the bid provider can dynamically adjust them depending on the current bidding conditions in order to obtain a balance between the number of bidders and income of the bid provider.

Referring to FIG. 11, there is shown a table illustrating a variety of functions of dynamically lowering bid price of a product according to the invention. T second(s) is taken as a time unit. The communication income R is a function of t. That is, R=F×t. Further, a number of equations are obtained as below. A communication income Ri is defined as Ri=Fi×ti. A communication subsidy Si is defined as Si=Ri×G %. An accumulated subsidy Ti is a summation of Si. The current bid price Mi is a subtraction Ti from cost.

In a first case that the bidding is busy (i.e., the number of bidders increased steadily) t is set as one second. That is, the apparatus will be updated per second for increasing the number of times of dynamically lowering bid price of a product. In a second case that the bidding is slow (i.e., the number of bidders reduced significantly) t is set as 10, 20, 30, or 60 seconds. That is, the apparatus will be updated per t second(s) for reducing the number of times of dynamically lowering bid price of a product. This can save system resources which is deemed as one of characteristics of the present invention. Note that as to the first case, the apparatus can readjust the value of time unit t as 1 by means of function ti if the accumulated subsidy Ti is excessively high due to a higher value of the subsidy ratio of G %. As a result, an appropriate, dynamic lowering of bid price is simultaneously carried out. This is deemed as another characteristic of the present invention.

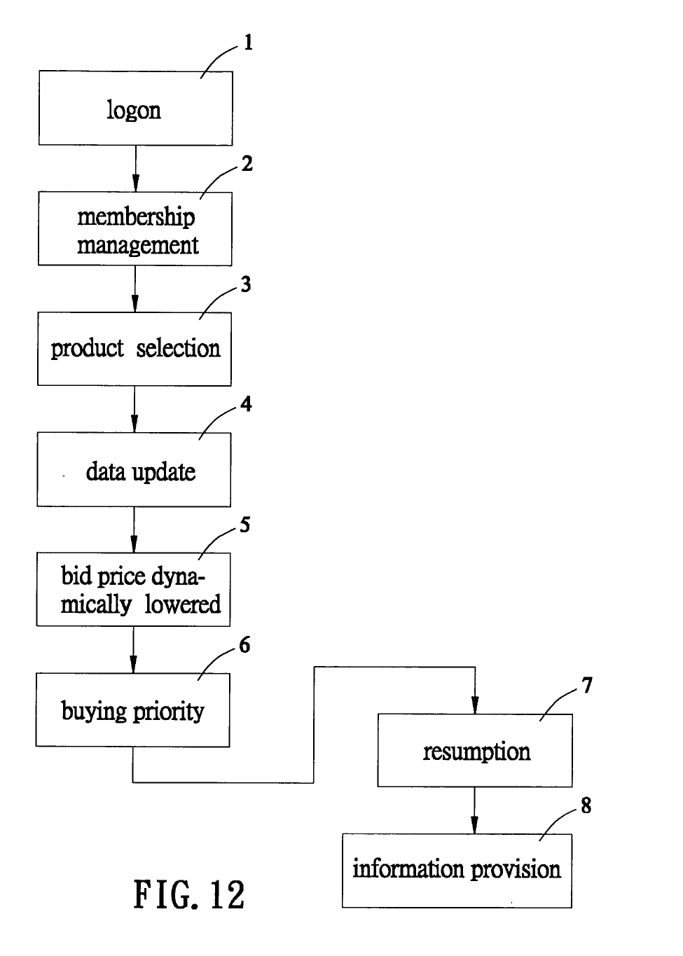

Referring to FIG. 12, there is shown a flow chart regarding an entering of a bidder according to the invention. This a closed bidding process. In step 1, a logon of a potential bidder is performed. In step 2, identify the bidder and gain access to a membership management system. A message is prompted to the bidder if such access is rejected. In step 3, a selection of products is available. The bidder can select a desired product prior to participating the bidding. In step 4, latest bid prices of the products and the number of the bidders online are updated per t second(s). In step 5, the bid price is updated (i.e., lowered in the invention) per t second(s). The difference between the initial bid price and the lowered one is Ti (i.e., the accumulated subsidy) equal to a subsidy ratio times the communication income. In step 6, one bidder can select a product for buying (i.e., having a buying priority). Further, the apparatus will inform the bidder for an immediate confirmation of such buying. Otherwise, the apparatus will cancel the buying priority if no confirmation from the bidder within a predetermined period of time. In step 7, a resumption is begun if the least bid had won, and the number of the sold product increases by one, bid price is equal to the initial bid price, and Ti (i.e., the accumulated subsidy) is equal to zero. In the final step 8, following information including bid winning time, date, product description, the number of products, total price, service center contact number, product taking procedure, etc. is provided to the bid winner based on the bid winner's eNumber.

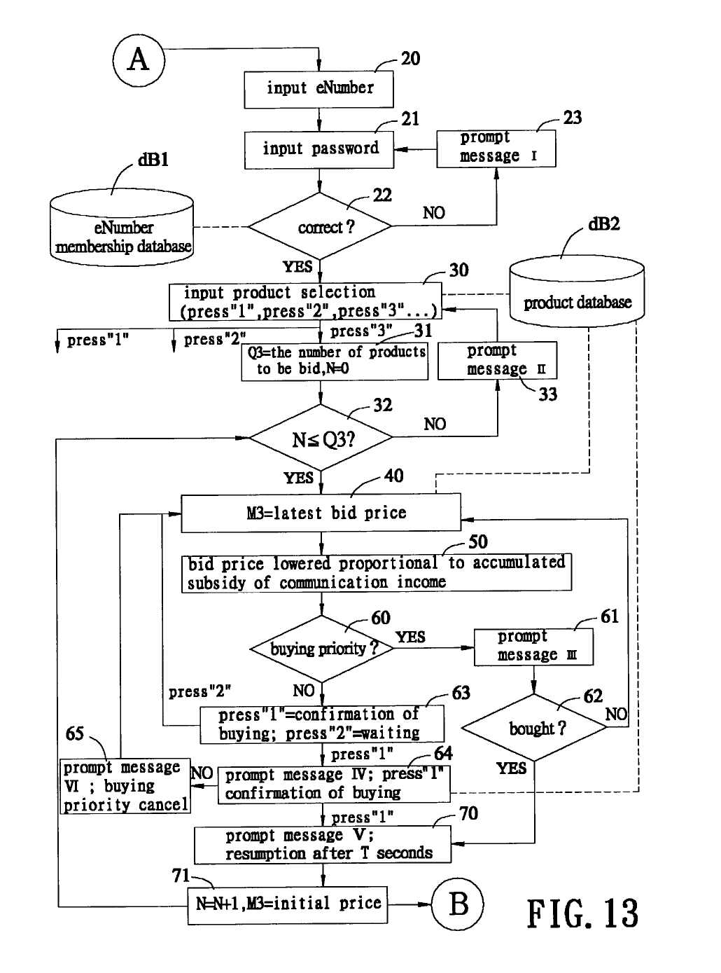

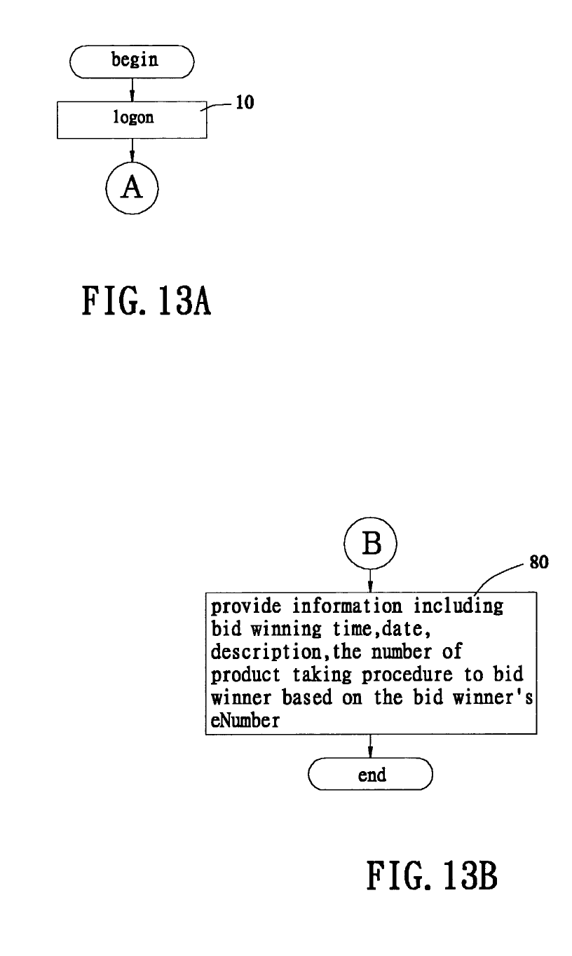

Referring to FIGS. 13, 13A, and 13B, a detailed process of the invention is illustrated below. In step 10, a logon of a potential bidder is performed. In step 20, input an eNumber assigned to a registered member. In step 21, input a password of the member. In step 22, the apparatus determines whether the eNumber and password are correct based on data contained in the eNumber membership database dB1. In step 23, message I is prompted if the determination in step 22 is negative. The process then goes to step 30 for selecting one of products available from the product database dB2. In step 31, the number of products to be bid Q3 and the number of sold products N (having an initial value of zero) are set. In step 32, the apparatus determines whether N is less than or equal to Q3. If no, the process goes to step 33. Otherwise, the process goes to step 40. In step 33, message 11 is prompted. In step 40, latest bid price of the product M3 and the number of the bidders online P3 are updated per one or more seconds. In step 50, the bid price is lowered per one or more seconds. The difference between the initial bid price and the lowered one is the accumulated subsidy as defined above. In step 60, the apparatus determines whether a bidder has selected a product for buying (i.e., having a buying priority). If yes, the process goes to step 61. Otherwise, the process goes to step 63. In step 61 message III is prompted. In step 62, the apparatus determines whether the product has been bought. If yes, the process goes to step 70. Otherwise, the process loops back to step 40. In step 63, a pressing of “1” a confirmation of the buying or a pressing of “2” a cancel of the buying (i.e., waiting for a lower bid price) prior to looping back to step 40. In step 64, message IV for confirming the buying is prompted if “1” is pressed as prompt message indicated in step 63 else the process goes to step 65 for canceling the buying priority (prompt message VI) prior to looping back to step 40. In step 70 message V is prompted if “1” is pressed as indicated in step 64. Further, a resumption is begun after T seconds have passed. In step 71, N is increased by one, M3 is set as the initial bid price, the accumulated subsidy T is set as zero, and resumption is begun. In the final step 80, following information including bid winning time, date, product description, the number of products, total price, service center contact number, product taking procedure, etc. is provided to the bid winner based on the bid winner's eNumber.

Note that a bid unit can be one product per bidding or a batch of products (containing a number of products) per bidding depending on bidding conditions.

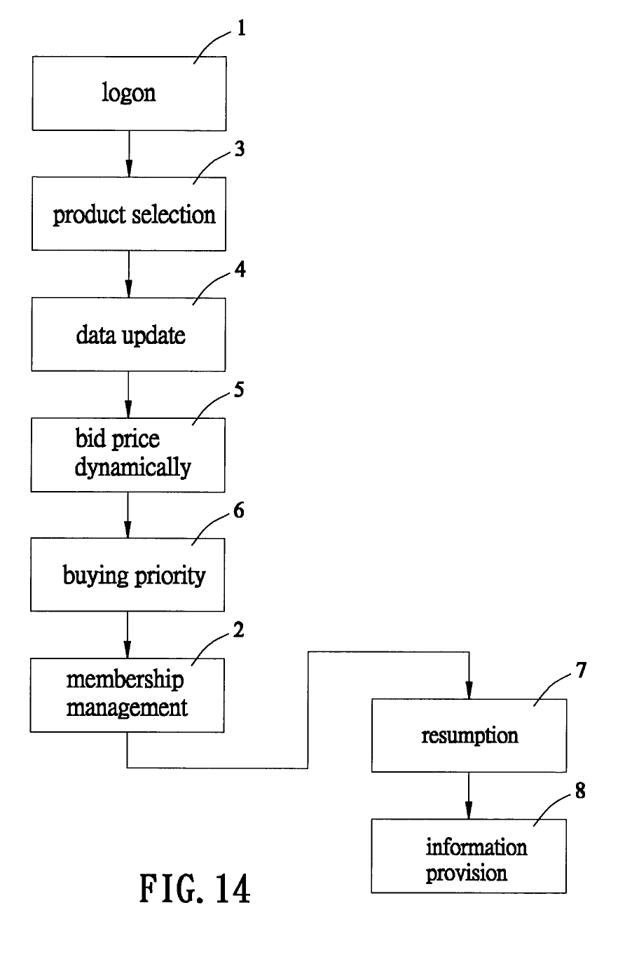

Referring to FIG. 14, there is shown a variation of the process shown in FIG. 12. The difference therebetween is that the membership management system as detailed in step 2 of FIG. 12 is moved to a step between step 6 and step 7 of FIG. 14.

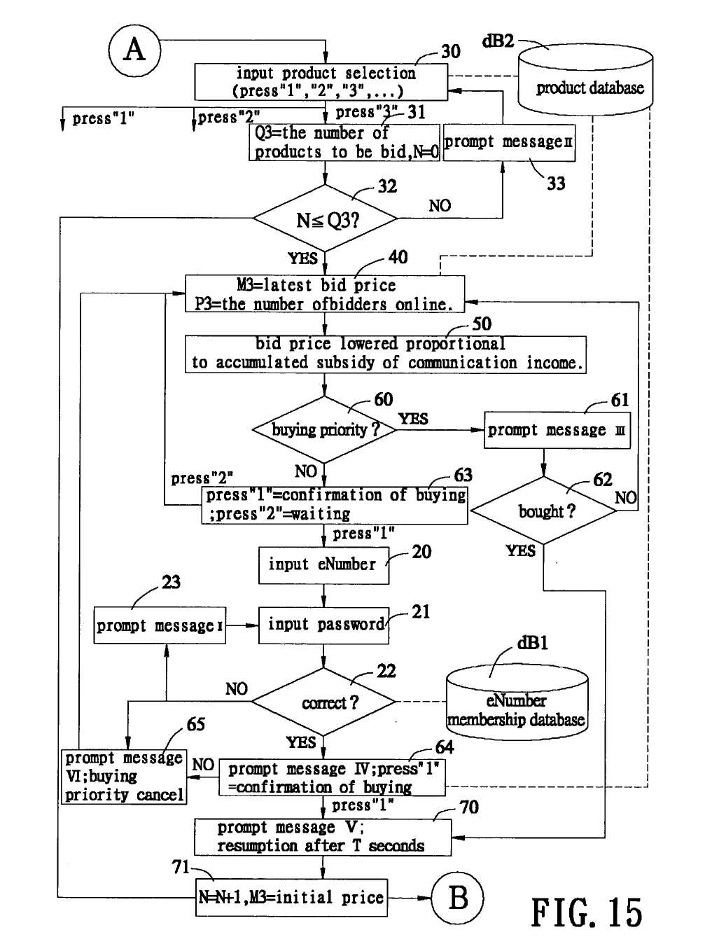

Referring FIG. 15, there is shown a variation of the process shown in FIGS. 13, 13A, and 13B. The differences therebetween are that step 20 regarding eNumber of member, step 21 regarding password of member, step 22 regarding the determination of correct eNumber and password, and step 23 regarding message I prompting of FIG. 13 are moved to steps after step 63 regarding a confirmation of the buying or not. In brief, this variation is an open bidding process.

Note that the eNumber of the registered member can be a telephone number or a cellular phone number, a system code, or a number chosen by the bidder as long as it can identify the member to the apparatus.

Further note that in step 80 information provided to the bid winner can be sent through mails, short messages, call-outs, pagers, the Web, TVs, radios, newspapers, and magazines. Such information broadcasting may additionally form business relationship with a same field or different field of other trade entities for obtaining an additional advertisement profit therefrom. This is deemed as a further characteristic of the present invention.

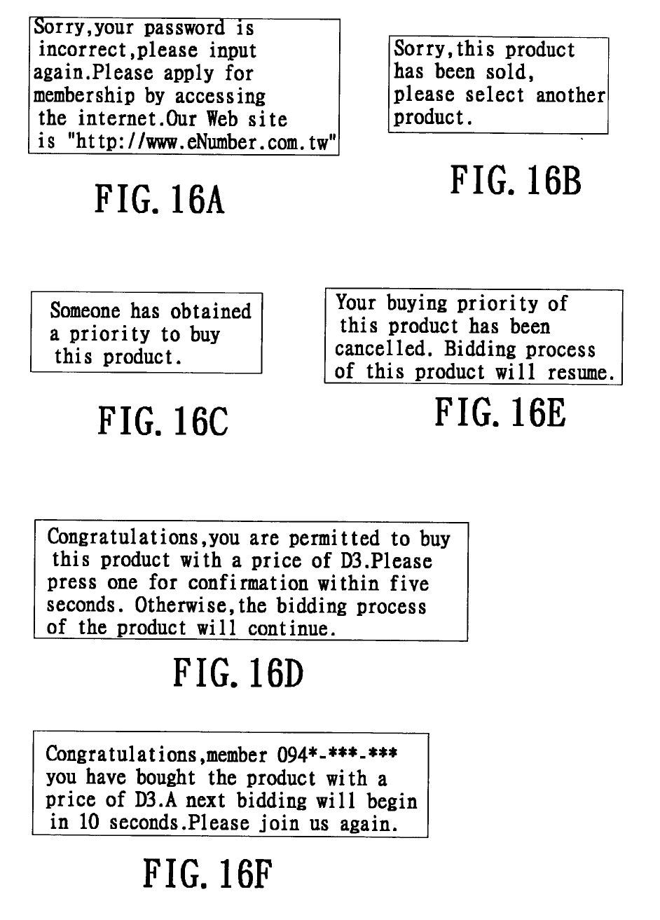

Referring to FIGS. 16A to 16F, the block diagrams regarding messages shown in the first to the sixth preferred embodiments of the present invention respectively. Such messages can be prompted by means of voice, text, graphics, video, or a combination of the voice, text, graphics, and video. For example, In FIG. 16A message I may contain the following text “Sorry, your password is incorrect, please input again. Please apply for a membership by accessing the Internet. Our Web site is “http://www.eNumber.com.tw”. In FIG. 16B, message 11 may contain the following text “Sorry, this product has been sold, please select another product.” In FIG. 16C, message III may contain the following text “Someone has obtained a priority to buy the product”. In FIG. 16D, message IV may contain the following text “Congratulations, you are permitted to buy this product with a price of D3. Please press “1” for confirmation within five seconds. Otherwise, the bidding process of the product will continue.” In FIG. 16E, message VI may contain the following text “Your buying priority of this product has been cancelled. Bidding process of this product will resume.” In FIG. 16F, message V may contain the following text “Congratulations, member 094*** you have bought the product with a price of D3. A next bidding will begin in 10 seconds. Please join us again.”

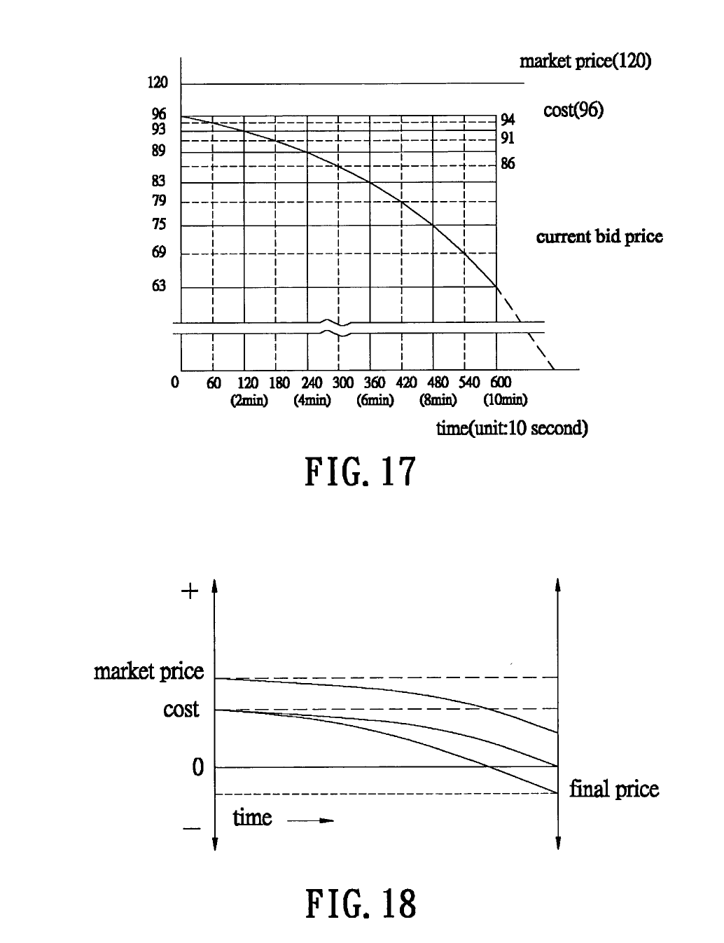

Referring to FIG. 17, it plots the current bid price versus time with reference to market price of 120 US dollars and cost of 96 US dollars (i.e., 80% of the cost) utilized in any preferred embodiment of the present invention. As shown, the current bid price of a product continues to fall as the bidding proceeds.

Referring to FIG. 18, it plots a detail of the final price versus a time unit of FIG. 17 with reference to market price and cost. In detail, the DPC 92 can integrate real time information about the bidding in order to dynamically lower bid price of a product and show corresponding messages to the bidders each using one a variety of communication devices for online bidding. With such configuration, the present invention can draw more people to join the bidding. Also, the bid price continues to fall as the bidding proceeds since both the number of bidders and the communication income are increased steadily. In a case that the cost of one product may fall below the product cost. In another case that the bid price may be zero, i.e., free. It is envisaged that the present invention can quickly sell one or more products per bidding. As a result, income of the bid provider can be increased significantly. Further, time involved in one bidding can be reduced significantly.

While the invention herein disclosed has been described by means of specific embodiments, numerous modifications and variations could be made thereto by those skilled in the art without departing from the scope and spirit of the invention set forth in the claims.

What is claimed is:

1. A process of dynamically lowering bid price of one of a plurality of products through network comprising:
calculating a communication income of a plurality of potential bidders every t seconds of time, and
appropriating a portion of the communication income as a subsidy for one of the products so that the bid price of the product is capable of being dynamically lowered.

2. A process of dynamically lowering bid price of one of a plurality of products through network comprising the steps of:
(a) a logon of a potential bidder;
(b) inputting a potential bidder's username and password; determining whether the username and the password are correct or not prior to permitting the bidder to enter a membership management system;
(c) permitting the bidder to select one of a plurality of products by pressing a corresponding number;
(d) updating the latest bid price of the selected product and the number of the bidders online per one or more seconds;
(e) lowering the bid price per one or more seconds wherein a difference between the initial bid price and the lowered one is an accumulated subsidy equal to a subsidy ratio times a communication income;
(f) assigning a buying priority of the selected product to the bidder prior to requiring the bidder to immediately confirm the buying and canceling the buying priority if no confirmation from the bidder within a predetermined period of time;
(g) resuming the process in response to bid winning, including the number of the sold products increased by one, the latest bid price equal to the initial bid price, and the accumulated subsidy equal to zero; and
(h) informing information including a bid winning time and date, a product description, a number of the products, a total price, a service center contact number, and a product taking procedure to a bid winner.

3. The process of claim 2, wherein the username is an eNumber assigned by the membership management system.

4. The process of claim 2, wherein in the step (b) the determination is based on data contained in an eNumber membership database.

5. The process of claim 2, wherein in the step (c) further comprises the step (c1) of providing the number of the products to be bid and the number of sold products by accessing a product database.

6. The process of claim 2, wherein in the step (h) further comprises the step (h1) of informing information including the bid winning time and date, the product description, the number of the products, the total price, the service center contact number, and the product taking procedure to the bid winner based on the bid winner's eNumber.

7. The process of claim 2, wherein in the step (b) further comprises the step of (b1) prompting a message of “Sorry, your password is incorrect, please input again. Please apply for a membership by accessing the Internet. Our Web site is “http://www.eNumber.com.tw”; in the step (c) further comprises the steps of (c2) prompting a message of “Sorry, the product has been sold, please select another product”; in the step (f) further comprises the step of (f1) prompting a message of “Someone has obtained a priority to buy the product”; (f2) prompting a message of “Congratulations, you are permitted to buy the product with a price of D3. Please press one for confirmation within five seconds. Otherwise, the bidding process of the product will continue”, and (f3) prompting a message of “Your buying priority of the product has been cancelled. Bidding process of the product will resume”; and in the step (g) further comprises the step of (g1) prompting a message of “Congratulations, member 094*-***-*** you has bought the product with a price of D3. A next bidding will begin in 10 seconds. Please join us again”.

8. The process of claim 2, wherein the eNumber is one of a telephone number assigned to a local call or a cellular phone, a system code, a number chosen by the bidder, and a number for effecting a connection between one of consumers and the bid provider.

9. The process in claim 2, wherein information provided in accordance with the eNumber of the bid winner is sent through mails, short messages, call-outs, pagers, the Web, TVs, radios, newspapers, and magazines depending on applications.

10. A process of dynamically lowering bid price of one of a plurality of products through network comprising the steps of:
(A) defining a type of charge as charge by time, charge by times, charge by data size of 128 bytes, charge by point, or charge by membership fee;
(B) correspondingly defining a parameter as a variable of A, B, C, D, or E;
(C) correspondingly defining a type of charge unit as a second as a first unit, a plurality of times of communication per second as a unit, a predetermined bytes of communication per second as a unit, a predetermined points deduction per second as a unit, or a second as a second unit;
(D) correspondingly defining a rate equation as A, Z×B, (Y/128)×C, W×D, or E/(30×24×60×60); and
(E) correspondingly defining the number of the online bidders as Hi, Ii, Ji, Ki, or Li.

11. The process of claim 10, wherein a communication income per second is a summation of respective one of the rate equations times the corresponding number of the online bidders.

12. The process of claim 2, further comprising the step (F) of defining t second(s) as a time unit for updating the bid price.

13. The process of claim 12, wherein the communication income is the communication income per time unit times a period of time t defined as Ri=Fi * ti, a communication subsidy is the subsidy ratio G % times the communication income defined as Si=Ri * the subsidy ratio G %, the accumulated subsidy is a summation of respective ones of the communication subsidy defined as Ti=Σ Si, and the latest bid price is a subtraction of the accumulated subsidy from a cost of the product defined as Mi=the cost−Ti.

14. The process of claim 12, wherein the time unit is one second if the number of the online bidders is more than a predetermined value, and the period of time t is adjusted by means of a ti function if the accumulated subsidy Ti=Σ Si is higher than a predetermined price due to the subsidy ratio G % in order to maintain an appropriate lowering of the bid price.

15. The process of claim 12, wherein the time unit is 10, 20, 30, or 60 seconds if the number of the online bidders is less than or equal to the predetermined value.

16. The process in any one of claims 5, wherein each of the messages is prompted by means of voice communication, text communication, graphics communication, video communication, or combinations thereof.

17. The process in any one of claims 6, wherein each of the messages is prompted by means of voice communication, text communication, graphics communication, video communication, or combinations thereof.

18. The process in any one of claims 7, wherein each of the messages is prompted by means of voice communication, text communication, graphics communication, video communication, or combinations thereof.

19. A process of dynamically lowering bid price of one of a plurality of products comprising utilizing a DPC (Data Processing Center) having a mechanism for dynamically lowering bid price to form a bidding network accessible by means of voice communication, text communication, graphics communication, video communication, or combinations thereof; defining t seconds as a time unit; charging one of a plurality of potential bidders by means of parameters; calculating a communication income from the bidders, each accessing the bidding network by means of voice communication, text communication, graphics communication, video communication, or combinations thereof in each time unit; and appropriating a portion of the communication income as a subsidy for one of the products by means of the DPC so that the bid price of the product is capable of being dynamically lowered throughout the process.

20. A process of dynamically lowering bid price of one of a plurality of products through network comprising the steps of:
(a) a logon of a potential bidder;
(b) permitting the bidder to select one of a plurality of products by pressing a corresponding number;
(c) updating the latest bid price of the selected product and the number of the bidders online per one or more seconds;
(d) lowering the bid price per one or more seconds wherein a difference between the initial bid price and the lowered one is an accumulated subsidy equal to a subsidy ratio times a communication income;
(e) assigning a buying priority of the selected product to the bidder prior to requiring the bidder to immediately confirm the buying and canceling the buying priority if no confirmation from the bidder within a predetermined period of time;
(f) inputting a potential bidder's username and password; determining whether the username and the password are correct or not prior to permitting the bidder to enter a membership management system;
(g) resuming the process in response to bid winning, including the number of the sold products increased by one, the latest bid price equal to the initial bid price, and the accumulated subsidy equal to zero; and
(h) informing information including a bid winning time and date, a product description, the number of the products, a total price, a service center contact number, and a product taking procedure to a bid winner.

21. An apparatus for dynamically lowering bid price of one of a plurality of products through network supported by having a voice sending and a text sending mechanism comprising:
a PBX (Private Branch exchange) coupled to a telephone of a plurality of bidders via a first dedicated line and a PSTN (Public Switch Telephone Network);
a DPC (Data Processing Center) coupled to the PBX, the DPC comprising an IVR (Interactive Voice Response) for exchanging voice in a local call and a cellular phone and a SMS (Simple Message Server) for exchanging text in a WAP (Wireless Application Protocol), sending short messages to a cellular phone, and sending messages to a pager; and
a database coupled to the DPC, the database including an eNumber membership database and a product database;
wherein a bidding network accessible by means of voice and text communication is formed, the bidder obtains detailed descriptions, bid prices, etc. of products by means of voice or text in communication; and
wherein during bidding, the DPC integrates real time information about the bidding in order to dynamically lower bid price of a product and show corresponding messages to the bidders.

22. An apparatus for dynamically lowering bid price of one of a plurality of products through network supported by having a voice sending, a text sending, and a graphics sending mechanism comprising:
a PBX (Private Branch exchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising an IVR (Interactive Voice Response) for exchanging voice in a local call and a cellular phone, a SMS (Simple Message Server) for exchanging text in a WAP (Wireless Application Protocol), sending short messages to a cellular phone, and sending messages to a pager, and a Web server for exchanging graphics in communication among Web pages, GPRSs (General Packet Radio Services), and MMSs (Multimedia Message Services); and
a database coupled to the DPC, the database including an eNumber membership database and a product database;
wherein a bidding network accessible by means of voice, text, and graphics communication is formed, the bidder obtains detailed descriptions, bid prices, etc. of products by means of voice or text or graphics communication; and
wherein during bidding, the DPC integrates real time information about the bidding in order to dynamically lower bid price of a product and show corresponding messages to the bidders.

23. An apparatus for dynamically lowering bid price of one of a plurality of products through network supported by having a voice sending, a text sending, and a video sending mechanism comprising:
a PBX (Private Branch eXchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising an IVR (Interactive Voice Response) for exchanging voice in a local call and a cellular phone, a SMS (Simple Message Server) for exchanging text in a WAP (Wireless Application Protocol), sending short messages to a cellular phone, and sending messages to a pager, and a video server for exchanging video in communication among Web pages, a cable TV, and a PHS (Personal Handyphone System) or 3G (3rd Generation cellular phone); and
a database coupled to the DPC, the database including an eNumber membership database and a product database;
wherein during bidding, the DPC is activated by a logon of the bidder through a bidding network accessible by means of voice, text, or video communication by the telephone or the remote computer to integrate real time information about the bidding in order to dynamically lower the bid price of the product and show a corresponding message to the bidder.

24. An apparatus for dynamically lowering bid price of one of a plurality of products through network supported by having a voice sending, a text sending, a graphics sending and a video sending mechanism comprising:
a PBX (Private Branch eXchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising an IVR (Interactive Voice Response) for exchanging voice in a local call and a cellular phone, a SMS (Simple Message Server) for exchanging text in a WAP (Wireless Application Protocol), sending short messages to a cellular phone, and sending messages to a pager, a Web server for exchanging graphics in communication among Web pages, GPRSs (General Packet Radio Services), and MMSs (Multimedia Message Services), and a video server for exchanging video in communication among Web pages, a cable TV, and a PHS (Personal Handyphone System) or 3G (3rd Generation cellular phone); and
a database coupled to the DPC, the database including an eNumber membership database and a product database;
wherein during bidding, the DPC is activated by a logon of the bidder through a bidding network accessible by means of voice, text, graphics, or video communication through the telephone or the remote computer to integrate real time information about the bidding in order to dynamically lower the bid price of the product and show a corresponding message to the bidder.

25. An apparatus for dynamically lowering bid price of one of a plurality of products through network supported by having a voice sending and a graphics sending mechanism comprising:
a PBX (Private Branch exchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising:
an IVR (Interactive Voice Response) for exchanging voice in a local call and a cellular phone; and
a Web server for exchanging graphics in communication among Web pages, GPRSs (General Packet Radio Services), and MMSs (Multimedia Message Services); and
a database coupled to the DPC, the database including an eNumber membership database and a product database;
wherein during bidding, the DPC is activated by a logon of the bidder through a bidding network accessible by means of voice or graphics communication by the telephone or the remote computer to integrate real time information about the bidding in order to dynamically lower the bid price of the product and show a corresponding message to the bidder.

26. An apparatus for dynamically lowering bid price of one of a plurality of products through network supported by having a voice sending and a video sending mechanism comprising:
a PBX (Private Branch eXchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising:
an IVR (Interactive Voice Response) for exchanging voice in a local call and a cellular phone; and
a video server for exchanging video in communication among Web pages, a cable TV, and a PHS (Personal Handyphone System) or 3G (3rd Generation cellular phone); and
a database coupled to the DPC, the database including an eNumber membership database and a product database;
wherein during bidding, the DPC is activated by a logon of the bidder through a bidding network accessible by means of voice or video communication by the telephone or the computer to integrate real time information about the bidding in order to dynamically lower the bid price of the product and show a corresponding message to the bidder.

27. An apparatus for dynamically lowering bid price of one of a plurality of products through network supported by having a text, a graphics and a video sending mechanism comprising:
a PBX (Private Branch eXchange) coupled to a telephone of a plurality of bidders via a first dedicated line and a PSTN (Public Switch Telephone Network);
a DPC (Data Processing Center) coupled to the PBX and a remote computer of another bidder via a second dedicated line and a WWW (World Wide Web) respectively, the DPC comprising:
a SMS (Simple Message Server) for exchanging text in a WAP (Wireless Application Protocol), sending short messages to a cellular phone, and sending messages to a pager;
a Web server for exchanging graphics in communication among Web pages, GPRSs (General Packet Radio Services), and MMSs (Multimedia Message Services); and
a video server for exchanging video in communication among Web pages, a cable TV, and a PHS (Personal Handyphone System) or 3G (3rd Generation cellular phone); and
a database coupled to the DPC, the database including an eNumber membership database and a product database;
wherein during bidding, the DPC is activated by a logon of the bidder through a bidding network accessible by means of text, graphics or video communication by the telephone or the computer to integrate real time information about the bidding in order to dynamically lower the bid price of the product and show a corresponding message to the bidder.

28. An apparatus for dynamically lowering bid price of one of a plurality of products through network supported by having a graphics and a video sending mechanism comprising:
a DPC (Data Processing Center) coupled to a remote computer of another bidder via a first dedicated line and a WWW (World Wide Web), the DPC comprising:
a Web server for exchanging graphics in communication among Web pages and a video server for exchanging video in communication among Web pages; and
a database coupled to the DPC, the database including an eNumber membership database and a product database;
wherein during bidding, the DPC is activated by a logon of the bidder through a bidding network accessible by means of graphics or video communication by the computer to integrate real time information about the bidding in order to dynamically lower the bid price of the product and show a corresponding message to the bidder.
